(19) United States
(12) Patent Application Publication
(10) Pub. No.: US 2019/0301859 A1
(43) Pub. Date: Oct. 3, 2019

(54) METHOD FOR DETERMINING PARAMETERS OF THE VEHICLE GEOMETRY OF WHEELS OF A NON-ARTICULATED AXIS, USE OF THE METHOD, TEST STAND FOR A VEHICLE AND MEASURING UNIT

(71) Applicant: DÜRR Assembly Products GmbH, Püttlingen (DE)

(72) Inventors: André Deutsch, Herbitzheim (FR); Thomas Kolb, Blieskastel (DE); Simon Stroh, Saarwellingen (DE); Thomas Tentrup, Merzig-Mechern (DE)

(21) Appl. No.: 16/317,409

(22) PCT Filed: Jul. 12, 2017
(86) PCT No.: PCT/DE2017/100575

§ 371 Date: Jan. 11, 2019

(30) Foreign Application Priority Data
Jul. 12, 2016 (DE) 10 2016 112 712.4

(51) Int. Cl. G01B 11/275

(52) U.S. Cl. CPC G01B 11/2755; G01B 2210/286

(57) ABSTRACT

The present invention relates to a method for determining parameters of the chassis geometry of wheels of a non steered axle, amuse of the method, a test bench for a vehicle, and a measuring unit. The method relates to determining the parameters of the chassis geometry of the Wheels of the rear axle of a vehicle from measurements of the toe angle in two measuring positions of the vehicle in the test bench, which positions are mutually offset in the x-direction. Wheel runout compensation is achieved thereby. The geometric driving axle thus determined can be used for setting driver assistance systems and for setting the parameters of the chassis geometry of the steered wheels of the front axle. A measuring unit can be designed such that a plurality of parallel lines for generating a planar pattern are generated by means of a parallel displacement of a sensor in the x-direction, which sensor emits linear light having one line. A linear sensor of this kind can in turn be replaced by a sensor comprising a point light source by means of which a line is scanned.

### PRIOR APPLICATIONS

This application claims priority to and all advantages of PCT/DE2017/100575, filed Jul. 12, 2017 and German Patent Application No, DE 102016112712.4, tiled Jul. 12, 2016, the content of which is hereby incorporated by reference.

### TECHNICAL FIELD

The present invention relates to a method for determining parameters of the chassis geometry of wheels of a non-steered axle of a vehicle according to the preamble of claim 1, a use of the method according to claims 2 and 3, a test bench according to claim 4, and a measuring unit according to claim 6.

### BACKGROUND

WO 2010/025723 A1 already discloses determining, for a vehicle in a test bench, parameters of the chassis geometry of wheels of a non-steered axle of a vehicle in a test bench. In this case the parameters of the chassis geometry of the wheels are ascertained in that each wheel of each side of the vehicle is associated with one measuring unit, respectively, which measuring unit acquires at least one parameter of the orientation of the relevant wheel plane based on a frame of reference assigned to the test bench (test bench frame of reference). In the case of the procedure described therein, measurements of the parameters of the chassis geometry are made in two positions in the longitudinal direction of the test bench (x-direction). In the case of the procedure described therein, the parameters of the Wheels of both the steered and the non-steered axle are acquired in both positions. In order, in the process, to be able to also take account of a steering lock in the case of the wheels of the steered axle, the steer angle is furthermore acquired in both positions of the vehicle, using the steering wheel position (in conjunction with the steering ratio).

In this prior art, the measuring unit acquires the at least one parameter of the orientation of the relevant wheel plane by means of a planar pattern being projected onto the wheel. The evaluation of the image of the planar pattern allows tier the location of the plane of the wheel to be determined. This procedure is described for example in EP 0 280 941 A1.

### SUMMARY

The object of the present invention is that of reducing the complexity when determining the wheel runout-compensated parameters of the chassis geometry of wheels of a vehicle.

For this purpose, claim 1 proposes determining parameters of the chassis geometry of wheels of a non-steered axle of a vehicle in a test bench, wherein the parameters of the chassis geometry of the wheels of the non-steered axle are ascertained in that, on the non-steered axle, the wheel of each side of the vehicle is associated with one measuring unit, respectively, which measuring unit acquires at least one parameter of the orientation of the relevant wheel plane based on a test bench frame of reference.

According to claim 1, for a first position of the vehicle in the test bench, at least one parameter (δ1) of the orientation of a vehicle-related, frame of reference relative to the test bench frame of reference is determined in said first position. Furthermore, in said first position, the measuring units that are assigned to the wheels of the non-steered axle acquire measured values for determining at least one parameter of the orientation of the relevant wheel planes and/or ascertain from said measured values the at least one parameter of the orientation of the relevant wheel planes and/or a value derived therefrom. Furthermore, the vehicle is moved into a second position of the vehicle in the test bench, which position is offset, in the longitudinal direction of the vehicle in the test bench, relative to the first position. For the second position of the vehicle in the test bench, the at least one parameter (δ2) of the orientation of the vehicle-related frame of reference relative to the test bench frame of reference is determined in said second position. In the second position, the measuring units that are assigned to the wheels of the non-steered axle in said second position acquire measured values for determining, the at least one parameter of the orientation of the relevant wheel planes in said second position and/or ascertain the at least one parameter of the orientation of the relevant wheel plane and/or a value derived therefrom.

The measured values for determining the at least one parameter of the orientation of the relevant wheel planes and/or the at least one parameter of the orientation of the relevant wheel planes that was ascertained from the acquired measured values, and/or the value derived therefrom in the first position and in the second position are converted, taking account of the at least one parameter δ1, δ2), of the orientation of the vehicle-related frame of reference relative to the test bench frame of reference in the first position and in the second position, such that the converted measured values for determining the at least one parameter of the orientation of the relevant wheel planes and/or the converted at least One parameter of the orientation of the relevant wheel planes that was ascertained from the acquired measured values, and/or the converted value derived therefrom in the first position and in the second position are provided on the basis of a common frame of reference.

Furthermore, wheel runout-compensated converted measured values for determining at least one parameter of the orientation of the relevant wheel planes and/or at least one wheel runout-compensated converted parameter of the orientation of the relevant wheel planes and/or a wheel runout-compensated converted value derived therefrom are ascertained, based on the common frame of reference in each case, from the converted measured values for determining at least one parameter of the orientation of the relevant wheel planes and/or the converted at least one parameter of the orientation of the relevant wheel planes and/or the converted value derived therefrom in the first position and in the second position, in the common frame of reference in each case, taking account of the spacing of the first position from the second position in the x-direction and the diameter of the wheels of the non-steered axle.

The present invention is therefore based on the finding that determination of the parameters of the wheels of the rear axle in the common frame of reference is possible only by means of measuring the parameters of the non-steered axle (i.e. the rear axle of the vehicle). This reduces complexity in the design of the measurement technology and in the evaluation, because the parameters of the wheels of the steered axle can be ignored in this case. It is thus in particular not necessary to additionally acquire the parameters of the wheels of the steered axle, in the two measuring positions, in order to determine the parameters of the wheels of the non-steered axle.

The measurements that relate to the determination of the orientation of the wheel plane are carried out in the two measuring positions. Said measurements are made using the measuring units which are calibrated to the test bench frame of reference. In order to be able to jointly evaluate the measurements in the two measuring positions, for the purpose of wheel runout compensation it is necessary to convert said two measurements to a common frame of reference. This is necessary because the location of the vehicle-related frame of reference relative to the test bench frame of reference need not correspond in the two measuring positions of the vehicle. In other words, the orientation of the vehicle relative to the test bench may change when said vehicle moves from the first measuring position to the second measuring position.

Without restricting the generality for a different selection of a common frame of reference, the ratios will be explained by the following equations:

For the left-hand side of the vehicle:

α_{h1,B,BZ}=α_{h1,B,ca1}−δ_{B} (1a)

α_{b1,A,BZ}=α_{h1,A,ca1}−δA (2a)

for the right-hand side of the vehicle:

α_{hr,B,BZ}=α_{hr,B,ca1}+δ_{B} (1b)

α_{hr,A,BZ}=α_{hr,A,ca1}+δA (2b)

In this case, the variable a represents the toe angle of the relevant wheel. The indices are defined as follows:
δ: this is the deviation of the location of the vehicle-related frame of reference relative to the test bench frame of reference,
A: the variable relates to the measuring position A,
B: the variable relates to the measuring position B,
BZ: means that the variable relates to the defined vehicle-related frame of reference (BZ),
h1: the variable relates to the rear, left-hand wheel,
hr: the variable relates to the rear, right-hand wheel,
ca1: the variable relates to the measuring unit that is calibrated to the test bench frame of reference.

The values measured by the measuring units in the positions A and B (i.e. the relevant values “α_{ca1}”) are converted into a common frame of reference BZ using the equations (1) and (2) and in accordance with the relevant orientation “δ” of the vehicle-related frame of reference in the relevant position relative to the test bench frame of reference. Said frame of reference BZ is thus the vehicle-related frame of reference.

It is clear in the case that the ratios for the measured values at the wheel of the non-steered axle on the other side of the vehicle (i.e. in this case the rear right-hand wheel) are analogous, when the indices are adjusted accordingly.

In said conversion, the relevant orientation “δ” is subtracted out, so as to result in the provision of the relevant values “α” in the vehicle-related frame of reference.

Provided that the vehicle is moved in the x-direction over a distance that corresponds to half a wheel revolution, the wheel runout-compensated toe values α_{b1,BZ} and α_{hr,BZ} are ascertained by averaging the vehicle-related toe values in positions A and B, and the following applies:

α′_{h1,BZ}=(α_{b1,A,BZ}+α_{b1,B,BZ})/2 (3)

α′_{hr,BZ}=(α_{hr,A,BZ}+α_{hr,B,BZ})/2 (4)

The wheel runout-compensated toe values α′_{h1,B,ca1} and α′_{hr,B,ca1} in position B and in the frame of reference of the test bench are:

α′_{b1,B,ca1}=α′_{h1,B,BZ}+δ_{B} (5)

α′_{hr,B,ca1}=α′_{hr,B,BZ}−δ_{B} (6)

In the frame of reference of the test bench, the geometrical direction of travel γB,_{ca1} of the vehicle in position B is found, using (5) and (6), by:

δ_{B,ca1}=(α′_{b1,B,ca1})/2 (7)

It is sufficient to carry out the stated measurements using measuring units that are based on the vehicle test bench. In addition to the measurements relating to the location of the wheel planes, the at least one parameter (δ) of the orientation of the vehicle-related frame of reference relative to the test bench frame of reference is ascertained. The vehicle-related frame of reference may be specified for example by the perpendicular of the connecting line between the centers of the wheels of the non-steered axle of the vehicle, which perpendicular is in the horizontal plane and is oriented forwards in the direction of travel of the vehicle. The test bench frame of reference is defined by the longitudinal direction of the test bench (x-direction). The test bench frame of reference is generally defined by the calibration gauge of the test bench. The measured values of the measuring units are provided in the test bench frame of reference to which the measuring units are calibrated.

The invention according to claim 1 makes it possible to convert the measurements made in each of the positions of the vehicle in the test bench into a common frame of reference of the vehicle which can be reproduced when carrying out measurements in another position of the vehicle in the test bench. For this purpose, it is necessary to ascertain the at least one parameter δ for each of the vehicle positions.

This makes it possible to compare measurements in different positions of the vehicle in the test bench with one another and also to evaluate a plurality of measurements at different positions together if said positions are previously based on the reproducible common frame of reference of the vehicle. This also applies when the orientation of the vehicle relative to the test bench is different in the different positions. That thus in particular also means that the vehicle-related frame of reference and the test bench frame of reference do not correspond.

Wheel runout compensation can be carried out using a conversion of this kind into a common frame of reference of the vehicle.

The selection of the suitable common frame of reference substantially depends on which further variables are to be ascertained from the measured data and for what purpose said variables are to be used.

For example, it is clear from equation (7) that a variable that is calculated from the measured values, specifically the geometric driving axle γ, is in a linear relationship with the measured values (toe angles). It is therefore irrelevant, for the end result,
whether the geometric driving axle is first ascertained for each of the positions and the geometric driving axle values thus obtained are subsequently offset against one another for the purpose of wheel runout compensation, or
whether wheel runout compensation of the measured values (toe angles) of the measurements in the two positions is first carried out, and the wheel runout-compensated geometric driving axle is then subsequently ascertained from said wheel runout-compensated measured values (toe angles).

Claim 2 relates to the use of the method according to claim 1 in a vehicle setting bench for measuring and setting driver assistance systems. Said driver assistance systems are systems and/or units of the vehicle for supporting the vehicle driver and/or for implementing an autonomous travel mode. The driver assistance systems are adjusted to the geometric driving axle of the vehicle. The geometric driving axle is ascertained using the method according to claim 1.

In said method according to claim 2, it has been found to be advantageous for it to thus be possible to measure the geometric driving axle, in a manner requiring little metrological complexity, for a vehicle setting bench for measuring and setting driver assistance systems (i.e. systems and/or units of the vehicle for supporting the vehicle driver and/or for implementing an autonomous travel mode), wherein the driver assistance systems are adjusted to the geometric driving axle of the vehicle.

Whereas, according tea the prior art, driver assistance setting benches of this kind required measuring units on the steered front axle and the non-steered rear axle in order to measure the geometric driving axle, it is possible according to the method described above to only measure the geometric driving axle at the rear axle, in positions A and B, using a measuring unit that is displaceable in the x-direction.

Claim 3 relates to the use of the method according to claim 1 in a chassis setting bench for measuring and setting parameters of the chassis geometry at wheels of a steered axle of the vehicle. In this case, the vehicle furthermore comprises at least one non-steered axle. Furthermore, the chassis setting bench comprises one wheel fixture, respectively, for the wheels of the steered axle of the vehicle on the right-hand and on the left-hand side of the vehicle. The wheel fixture consists in each case of a floating plate and a double roller, wherein at least one roller of the double rollers is drivable. The geometric driving axle is ascertained using the method according to claim 1.

Claim 3 describes the use of the method according to claim 1 for a chassis setting bench for parameters of the chassis geometry at wheels of a steered axle, wherein the parameters are adjusted on the basis of the driving axle of the vehicle. The vehicle comprises at least one non-steered axle. In order to measure the driving axle of the vehicle, the test bench has just two measuring positions in the x-direction, in which positions measuring units are provided which acquire at least one parameter of the chassis geometry of at least one non-steered axle of the vehicle.

As a result, the parameter of the wheels of the non-steered axle can be ascertained in a manner that is metrologically less complex than is known in the procedure according to WO 2010/025723 A1. In said procedure, one wheel fixture for each vehicle wheel must be provided in each case, for the two measuring positions. The present invention makes it possible to acquire the parameters of the wheels of the non-steered axle in a metrologically less complex manner (in particular without a wheel fixture for the wheels of the non-steered axle). It is nonetheless possible to set the parameters of the wheels of the steered axle, in the setting position thereof (i.e. when said wheels are positioned on the wheel fixtures), relative to the parameter of the wheels of the non-steered axle, which parameter was ascertained in a metrologically less complex manner.

For this purpose, the orientation of the vehicle-related frame of reference relative to the test bench frame of reference must still be acquired in the position in which the vehicle is positioned having the wheels of the steered axle on the wheel fixtures.

Claim 4 relates to a measuring, test and/or setting bench for vehicles, wherein the vehicle comprises at least one non-steered axle. In order to measure the driving axle of the vehicle, the test bench has just two measuring positions in the x-direction, in each of which positions one measuring, unit is provided for each wheel of a non-steered axle of the right-hand and left-hand side of the vehicle, wherein the measuring units acquire measured values for determining at least one parameter of the orientation of the wheel plane of the relevant wheel. An evaluation unit is furthermore provided, to which evaluation unit the measured values of the measuring units are supplied and in which evaluation unit the geometric driving axle is ascertained.

Claim 4 describes the technical features of a chassis bench by means of which the wheel runout-compensated determination of parameters of the chassis geometry of the wheels of the non-steered axle, for example the determination of the geometric driving axle, can be carried out according to the present invention.

Claim 5 relates to an embodiment of the measuring, test and/or setting bench according to claim 4, in which the measuring, test and/or setting bench is a chassis setting bench for measuring and setting parameters of the chassis geometry of wheels of the steered axle of the vehicle. The measuring, test and/or setting bench comprises one wheel fixture, respectively, for the wheels of the steered axle of the vehicle on the right-hand and on the left-hand side of the vehicle, wherein the wheel fixture in each case consists of a floating plate and a double roller. At least one of the double rollers is assigned a drive element in each case, for transferring a driving or braking torque to the at least one roller. The wheels of the steered axle are positioned on the relevant wheel fixture while the measuring, testing and/or setting work is being carried out. In order to measure the driving axle of the vehicle, the test bench has two measuring positions in the x-direction, in each of which positions one measuring unit is provided for each wheel of a non-steered axle of the right-hand and left-hand side of the vehicle. The measuring units acquire measured values for determining at least one parameter of the orientation of the wheel plane of the relevant wheel. An evaluation unit is furthermore provided, to which evaluation unit the measured values of the measuring units are supplied and in which evaluation unit at least the geometric driving axle for the vehicle in the position in which the wheels of the steered axle of the vehicle are positioned on the wheel fixtures is ascertained. A sensor unit is furthermore provided in this position in order to record changes in the orientation of the vehicle-related frame of reference relative to the test bench frame of reference.

Claim 5 describes the technical features of a chassis bench for acquiring and setting the parameters of the chassis geometry at the wheels of the steered axle. Said parameters of the chassis geometry of the wheels of the steered axle must be measured and set with respect to the geometric driving axle.

For this reason, the chassis bench comprises the technical means for acquiring the parameters of the orientation of the wheel planes of the wheels of the non-steered axle in the two measuring positions.

In the measuring and setting position of the vehicle (when the wheels of the steered axle are positioned on the wheel fixtures), it is necessary to acquire the orientation of the vehicle-related frame of reference. It is then possible to ascertain, for the measuring units of the wheels of the steered axle, the parameters of the orientation of said wheels with respect to the geometric driving axle.

For this purpose, the location of the vehicle-related frame of reference relative to the test bench frame of reference is known, in the measuring and setting position of the wheels of the steered axle, for example by means of measuring the wheel centers of the wheels of the non-steered axle of the vehicle.

Claim 5 describes an embodiment of the measuring, test and/or setting bench in which one of the measuring positions in the x-direction corresponds to the position of the wheels of the non steered axle of the vehicle in which the wheels of the steered axle of the vehicle are positioned on the relevant wheel fixture. In this case, the sensor unit and the measuring unit may be identical.

If for example the location of the vehicle-related frame of reference is defined by the location of the wheel centers of the wheels of the non-steered axle, it is possible to acquire the metrological acquisition of the location of the wheel centers of said wheels using a measuring unit that acquires the orientation of the wheel planes of said wheels.

Claim 6 relates to a measuring unit which is intended in particular for use in connection with one of the above-mentioned methods or one of the above-mentioned measuring, test and/or setting benches. In accordance with the known prior art, the measuring unit evaluates the image of a planar pattern that is projected onto the wheel surface. The orientation of the wheel plane is determined by means of the evaluation. In an embodiment of a known measuring unit, the planar pattern consists of a plurality of parallel lines. According to claim 6, the planar pattern is generated in that a sensor which emits light in a linear manner is oriented such that the line of said linearly emitted light is not oriented horizontally. Furthermore, the sensor can be displaced in the vehicle length direction (x-direction) in order to carry out a measurement of the orientation of the wheel plane. The image of the line of said sensor is evaluated in a plurality of positions of the sensor in the x-direction, in order to compose therefrom an image of a planar pattern consisting of a plurality of parallel lines.

In the case of this measuring unit, it has been found to be advantageous for the measuring unit that emits a plurality of lines simultaneously to be replaced by a sensor that emits just one line. Said sensor is associated with the test bench such that said sensor is movable in the longitudinal direction of the test bench. As a result, the scanning process of the sensor using just one line simulates the measurement using a plurality of parallel lines. The successively recorded images of the projected lines can be used immediately, in order to ascertain the orientation of the plane of the wheel from said planar image.

It is also possible to assemble the parallel lines of the planar pattern from connecting lines between points of the individual images of the linearly emitted light, which images result from the measurements at different positions of the sensor. It is thus possible to trace the measurement carried out using the obliquely oriented lines back to the measurement using the horizontally oriented lines of a multiline sensor.

In this case, the line of the sensor is oriented so as to be oblique with respect to the horizontal. This is related to the displacement of the sensor in the longitudinal direction of the vehicle (x-direction). In the case of a horizontal line, said line would simply be displaced “int itself”. A line that is oriented so as to be oblique to the horizontal is displaced in parallel by means of the displacement of the sensor.

Since, in the course of the further evaluation, the points having a common height on the imaged line are interconnected, parallel horizontal lines can thus be “simulated”.

In the embodiment according to claim 7, the line of sensor is generated in that the line is generated by a scanning process using a point light source.

In this case, it has been found to be advantageous that the complexity and the costs of the sensor can be further reduced.

In order to carry out the wheel runout compensation, the spacing in the x-direction between the two measuring positions must be known. There are various options for this. If the test bench comprises two measuring units on each side of the vehicle, the spacing thereof can be taken into account in the evaluation unit as the spacing between the two measuring positions. If the measuring units are displaceable in the x-direction (longitudinal direction of the test bench), the spacing of the two measuring positions in the x-direction can be ascertained from the distance by which the measuring units are displaced between the two measuring positions. It is likewise possible to ascertain said spacing on the basis of the wheel revolutions of the wheels of the vehicle if said vehicle rolls from the first measuring position to the second measuring position and the wheel circumference is known.

### BRIEF DESCRIPTION OF THE DRAWINGS

An embodiment of the invention is shown in the drawings. In said drawings:

FIG. 1: is a schematic view of a chassis bench,

FIG. 2: is a schematic view of a vehicle in the chassis bench in position A,

FIG. 3: is a schematic view of a vehicle in the chassis bench in position B,

FIG. 4-6: show wheels having lines projected thereon in each case.

### DETAILED DESCRIPTION

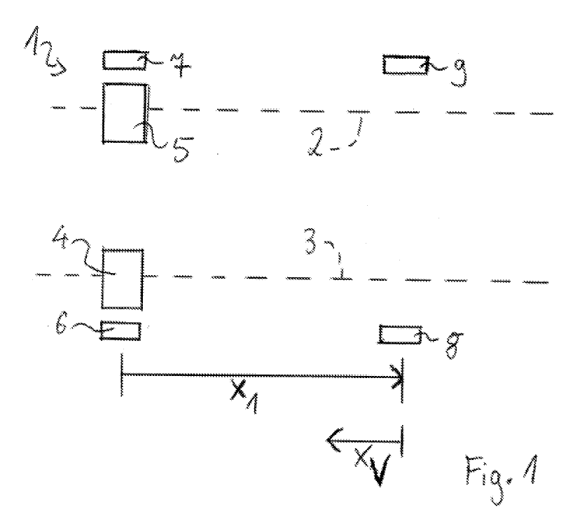

FIG. 1 is a schematic view of a chassis bench 1 for determining and setting the chassis geometry of a vehicle. Said chassis bench 1 comprises two ruts 2 and 3. One wheel fixture 4 and 5, respectively, is located in each of the ruts 2 and 3.

Said wheel fixtures are constructed such that they are mounted by means of a floating plate and comprise a double roller system on which the relevant wheel is positioned. In turn, at least one of the rollers of said double roller system is driven. As a result, each of the positioned wheels can be rotated uniformly by means of a rotation of the driven roller(s), without introducing mechanical stresses into the corresponding axle.

The positioned wheels are the wheels of the steered axle of the vehicle. This is the front axle in conventional vehicles.

One measuring unit 6 and 7, respectively, is assigned to each of said wheel fixtures 4 and 5, respectively. The fixed measuring units 6 and 7 for the front axle each have at least two triangulation sensors which illuminate the lateral face of the tire using at least one laser line, and thus measure the chassis geometry parameters. In this respect, reference is made for example to patent application EP 0 280 941 A1.

Said measuring units 6 and 7, respectively, acquire the parameters of the chassis geometry of wheels that are positioned on the relevant wheel fixtures 4 and 5, respectively.

Two further measuring probes 8 and 9 for measuring the rear axle are also visible, which measuring probes are located at a spacing x₁ in the longitudinal direction of a vehicle from the measuring probes 6 and 7. Said measuring probes 8 and 9 are displaceable over the entire vehicle length, from the fixed measuring units 6 and 7. This is indicated by the arrow x₁. The position of the measuring units 8 and 9 in the longitudinal direction (x-direction) is acquired in each case using a length measuring system.

It can furthermore be seen that said measuring probes 8 and 9 have a range x_{V} in which said measuring probes 8 and 9 are displaceable. While the measuring probes 8 and 9 are displaced in said range x_{V}, the measuring probes 8 and 9 carry out a plurality of measurements of parameters of the chassis geometry of wheels that are in each case located in the measuring range of the measuring probes 8 and 9.

Each of said measuring units 8 and 9 comprises two triangulation sensors which are arranged in a V-shape, such that the at least one laser line per triangulation probe radially illuminates the lateral face of the tire when the displaceable measuring units 8 and 9 are centered with respect to one of the rear wheels. Said radial illumination is advantageous in that in the process the image of the lines appears on the tires such that the bead of the tire is illuminated. As a result, the image of the line extends in a characteristic manner, and therefore changes are easy to identify.

The chassis parameters to be determined for each wheel are at least the toe angle and the coordinates of the wheel center in the horizontal (x,y plane).

The chassis bench comprises a calibration gauge which defines a base coordinate system when inserted into the bench, into which base coordinate system the coordinate systems of the four measuring units are transferred by measuring the inserted calibration gauge. This is the frame of reference assigned to the test bench.

The following method steps are carried out:

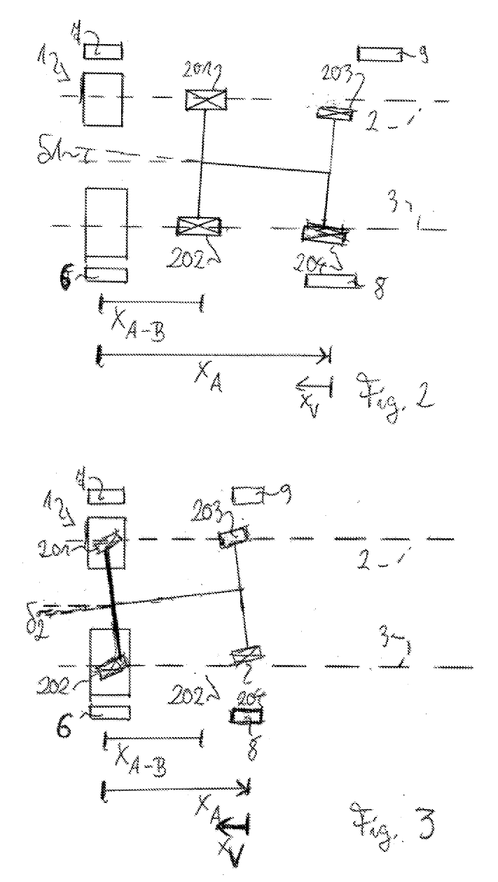

Moving the vehicle into a position A (FIG. 2) which is spaced apart from a position B (FIG. 3) such that the spacing between said two positions corresponds to half the circumference of a rear wheel of the vehicle. In this case, position B is defined in that the front wheels of the vehicle are positioned in the wheel fixtures 4, 5 so as to be at the front, between the rollers of the relevant double roller system.

Measuring the parameters of the rear wheels in position A of the vehicle in that a measurement is made on each side of the vehicle, such that in each case one measuring unit 8, 9 on each side of the vehicle is displaced in the vehicle length direction. This is a displacement of the measuring units 8 and 9, which is denoted in FIG. 2 (and in FIG. 3) by the arrow x_{V}. In this case, each of the two measuring units 8, 9, when displaced in the vehicle length direction (x_{V}), scans the contour of the lateral face of the tire of each of the rear wheels. The toe values of the rear wheels are ascertained from said contour measurement of the lateral face of the tire of the rear wheels.

For example the orientation of the perpendicular of the rear axle in the x,y plane with respect to the base coordinate system of the calibration gauge (test bench frame of reference) can be correlated with position A via the wheel centers. This is the determination of the at least one parameter of the orientation of the vehicle-related frame of reference (example: orientation of the perpendicular of the rear axle) relative to the test bench frame of reference (defined by the calibration gauge).

Moving the vehicle into position B (FIG. 3).

Measuring the chassis parameters of the rear wheels in position B of the vehicle in the say way as in position A. The toe values of the rear wheels are ascertained from the contour measurement of the lateral face of the tire of the rear wheels.

The orientation of the perpendicular of the rear axle in the x,y plane with respect to the base coordinate system of the calibration gauge (test bench frame of reference) measured in position B via the wheel centers. In this case it should be noted that said orientation of the perpendicular of the rear axle relative to the base coordinate system of the calibration gauge can change between positions A and B if the vehicle is not moved exactly in the longitudinal direction of the test bench. When being moved from position A into position B. This is the determination of the at least one parameter of the orientation of the vehicle-related frame of reference (in this example: orientation of the perpendicular of the rear axle) relative to the test bench frame of reference (defined by the calibration gauge) in position B.

Measuring the parameters of the front wheels in position B of the vehicle in that a measurement is made on each side of the vehicle such that a wheel runout measurement is made when the front wheels rotate, in order to compensate for the wheel runout. This measurement is carried out taking account of the steer angle.

Carrying out the wheel runout compensation of the rear wheels by means of averaging the toe angles with respect to the direction of the axle direction of the rear axle in position A and B.

Calculating the toe angle of the front and rear wheels in position B, based on the test bench frame of reference.

Ascertaining the direction of the axis of symmetry of the vehicle in position B of the vehicle.

Calculating the toe angle of the front axle with respect to the geometric driving axle and steering wheel position, and the toe angle of the rear axle with respect to the axis of symmetry in position B.

In this method, it has been found to be advantageous that just two wheel fixtures for rotating the front wheels are required in the chassis bench, but that the parameters of the chassis geometry can still be ascertained in a manner that takes full account of the wheel runout compensation, i.e. at the front and rear axle.

Displacing the measuring units and 9 causes the relevant wheel to be “covered” by the projected pattern.

The Wheel runout compensation for the rear wheels is achieved by moving the vehicle from position A into position B. This is described in patent application WO 2010/025723 A1. The parameters of the front wheels are ascertained by means of the wheel fixtures 4, 5 and the associated measuring units 6, 7, in a manner known per se, by means of the front wheels being rotated while the measurement is being carried out. As a result, a plurality of measurements are made at different angular positions by means of rotating the wheels. The steer angle can be taken into account by means of using a steering wheel balance.

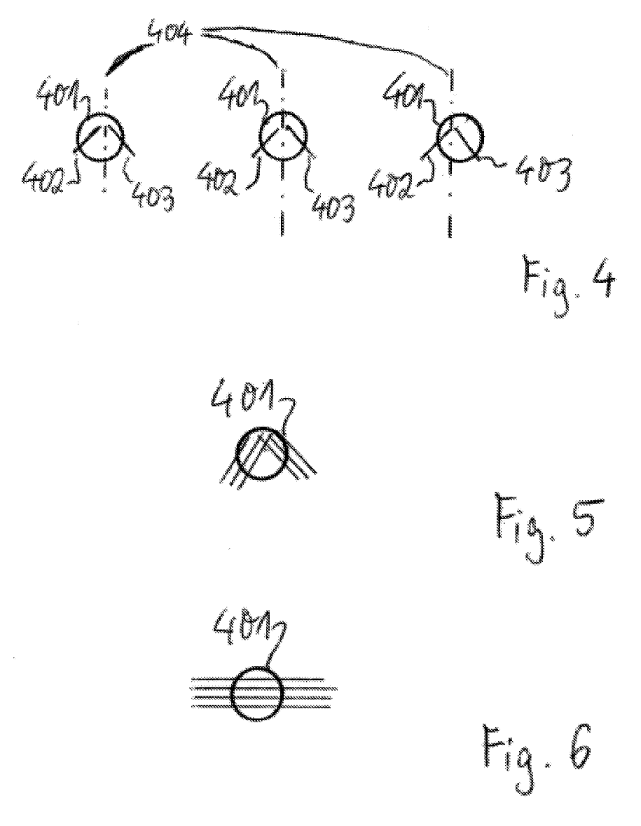

FIG. 4 is a schematic view of a rear wheel 401. It can be seen that the measuring probe is moved relative to the rear wheel. The measuring probe is represented by the projected lines 402 and 403. The center line 404 of the measuring probe is also shown. It can be seen in particular from the position of the center line 404 in the three views in FIG. 4 that the measuring probe is moved forwards, past the rear wheel 401, in the vehicle length direction of the vehicle. In the process, the lines 402 and 403 meet different points of the rear wheel 401.

It can be seen in this case that one of the lines 402, 403 would be sufficient for the scanning process for “simulating” the multiline sensor. The measuring unit is nonetheless depicted in the V-shape shown because it is thus possible to continuously determine the location of the plane of symmetry of the vehicle when the vehicle is stationary in position B, even without displacing the measuring units 8 and 9. It is not necessary to fully acquire the orientation of the wheel plane for this purpose. All that is important is the location of the wheel center, the changes of which can be acquired using the two V-shaped lines.

FIG. 5 shows the wheel 401 comprising a plurality of the projected lines 402 and 403, which lines were recorded at different time points during the displacement of the measuring probe relative to the rear wheel 401.

FIG. 6 shows that the lines can be evaluated such that the measuring points are separated in accordance with the z-coordinates thereof (i.e. with respect to the vertical position), and arranged into bands of measured values having similar z-coordinates. Said bands can be treated in the following as lines.

The present invention can be used for logging the measurements. Likewise, deviations from target values can be indicated, such that the parameters of the chassis geometry can be corrected by means of corresponding setting work.

1. Method for determining parameters of the chassis geometry of wheels of a non-steered axle of a vehicle in a test bench, wherein the parameters of the chassis geometry of the wheels of the non-steered axle are ascertained in that, on the non-steered axle, the wheel of each side of the vehicle is associated with one measuring unit, respectively, which measuring unit acquires at least one parameter of the orientation of the relevant wheel plane based on a test bench frame of reference,
characterized
in that, for a first position of the vehicle in the test bench, at least one parameter (δ1) of the orientation of a vehicle-related frame of reference relative to the test bench frame of reference is determined in said first position, and in that, in said first position, the measuring units that are assigned to the wheels of the non-steered axle acquire measured values for determining at least one parameter of the orientation of the relevant wheel planes and/or ascertain from said measured values the at least one parameter of the orientation of the relevant wheel planes and/or a value derived therefrom,
in that the vehicle is moved into a second position of the vehicle in the test bench, which position is offset, in the longitudinal direction of the vehicle in the test bench, relative to the first position,
in that, for the second position of the vehicle in the test bench, the at least one parameter (δ2) of the orientation of the vehicle-related frame of reference relative to the test bench frame of reference is determined in said second position, and in that, in the second position, the measuring units that are assigned to the wheels of the non-steered axle in said second position acquire measured values for determining the at least one parameter of the orientation of the relevant wheel planes in said second position and/or ascertain the at least one parameter of the orientation of the relevant wheel plane and/or a value derived therefrom,
in that the measured values for determining the at least one parameter of the orientation of the relevant wheel planes and/or the at least one parameter of the orientation of the relevant wheel planes that was ascertained from the acquired measured values, and/or the value derived therefrom in the first position and in the second position are converted, taking account of the at least one parameter (δ1, δ2) of the orientation of the vehicle-related frame of reference relative to the test bench frame of reference in the first position and in the second position, such that the converted measured values for determining the at least one parameter of the orientation of the relevant wheel planes and/or the converted at least one parameter of the orientation of the relevant wheel planes that was ascertained from the acquired measured values, and/or the converted value derived therefrom in the first position and in the second position are provided on the basis of a common frame of reference, and
in that wheel runout-compensated converted measured values for determining at least one parameter of the orientation of the relevant wheel planes and/or at least one wheel runout-compensated converted parameter of the orientation of the relevant wheel planes and/or a wheel runout-compensated converted value derived therefrom are ascertained, based on the common frame of reference in each case, from the converted measured values for determining at least one parameter of the orientation of the relevant wheel planes and/or the converted at least one parameter of the orientation of the relevant wheel planes and/or the converted value derived therefrom in the first position and in the second position, in the common frame of reference in each case, taking account of the spacing of the first position from the second position in the x-direction and the diameter of the wheels of the non-steered axle.

2. Use of the method according to claim 1 in a vehicle setting bench for measuring and setting driver assistance systems, wherein the driver assistance systems are adjusted to the geometric driving axle of the vehicle setting bench that was ascertained using the method according to claim 1.

3. Use of the method according to claim 1 in a chassis setting bench for measuring and setting parameters of the chassis geometry at wheels of a steered axle of the vehicle, wherein the vehicle further comprises at least one non-steered axle, wherein the chassis setting bench comprises one wheel fixture, respectively, for the wheels of the steered axle of the vehicle on the right-hand and on the left-hand side of the vehicle, wherein the wheel fixture in each case consists of a floating plate and a double roller, wherein at least one roller of the double rollers is drivable, wherein the geometric driving axle is ascertained using the method according to claim 1.

4. Measuring, test and/or setting bench for vehicles, wherein the vehicle comprises at least one non-steered axle, characterized in that, in order to measure the driving axle of the vehicle, the test bench has just two measuring positions in the x-direction, in each of which positions one measuring unit is provided for each wheel of a non-steered axle of the right-hand and left-hand side of the vehicle, wherein the measuring units acquire measured values for determining at least one parameter of the orientation of the wheel plane of the relevant wheel, wherein an evaluation unit is furthermore provided, to which evaluation unit the measured values of the measuring units are supplied and in which evaluation unit the geometric driving axle is ascertained.

5. Measuring, test and/or setting bench according to claim 4, characterized in that the measuring, test and/or setting bench is a chassis setting bench for measuring and setting parameters of the chassis geometry of wheels of the steered axle of the vehicle, wherein the measuring, test and/or setting bench comprises one Wheel fixture, respectively, for the wheels of the steered axle of the vehicle on the right-hand and on the left-hand side of the vehicle, wherein the wheel fixture consists in each case of a floating plate and a double roller, wherein at least one of the double rollers is assigned a drive element in each case, for transferring a driving or braking torque to the at least one roller, wherein the wheels of the steered axle are positioned on the relevant wheel fixture while the measuring, testing and or setting work is being carried out, characterized in that, in order to measure the driving axle of the vehicle, the test bench has two measuring positions in the x-direction, in each of which positions one measuring unit is provided for each wheel of a non-steered axle of the right-hand and left-hand side of the vehicle, wherein the measuring unit acquires measured values for determining at least one parameter of the orientation of the wheel plane of the relevant wheel, wherein an evaluation unit is furthermore provided, to which evaluation unit the measured values of the measuring units are supplied and in which evaluation unit at least the geometric driving axle is ascertained for the vehicle in the position, in the position of the vehicle in which the wheels of the steered axle of the vehicle are positioned, on the wheel fixtures, wherein a sensor unit is furthermore provided in this position in order to record changes in the orientation of the vehicle-related frame of reference.

6. Measuring unit, wherein the measuring unit evaluates the image of a planar pattern that is projected onto the surface of a wheel of a vehicle in order to determine the orientation of the wheel plane by means of the evaluation, wherein the planar pattern consists of a plurality of parallel lines, in particular for use in connection with one of the above-mentioned methods or one of the above-mentioned measuring, test and/or setting benches,
characterized in that the planar pattern is generated by means of a sensor which emits light in a linear manner being oriented such that the line of said linearly emitted light is not oriented horizontally, in that the sensor can be displaced in the vehicle length direction (x-direction) in order to carry out a measurement of the orientation of the wheel plane, wherein the image of the line of said sensor is evaluated in a plurality of positions of the sensor in the x-direction, in order to compose therefrom an image of a planar pattern consisting of a plurality of parallel lines.

7. Measuring unit according to claim 6,
characterized in that the line of sensor is generated in that the line is generated by a scanning process using a point light source.
